(19) United States
(12) Patent Application Publication
(10) Pub. No.: US 2006/0268244 A1
(43) Pub. Date: Nov. 30, 2006

(54) ZOOM LENS OF A PROJECTOR

(75) Inventors: Yung-Chang Lin, Taichung County (TW); Jung-Yao Chen, Taoyuan County (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ CORPORATION, Taoyuan Shien (TW)

(21) Appl. No.: 11/420,815

(22) Filed: May 30, 2006

(30) Foreign Application Priority Data
May 31, 2005 (TW) 94117884

(51) Int. Cl. G03B 21/14

(52) U.S. Cl. 353/101

(57) ABSTRACT

A zoom lens of projector including a first and a second lens groups disposed from the image side in order is provided. The first lens group has a negative effective power Φ_{U1}. The second lens group has a positive effective power Φ_{U2}. The zoom lens has an equivalent power Φ₀ and a back focal length BFL, where the BFL*Φ₀≧1.0, |Φ_{U1}|Φ₀>0.6, and Φ_{U2}/Φ₀>0.6. The size of the image projected on a screen by the projector is adjusted by adjusting the positions of the first lens group and the second lens group.

This application claims the benefit of Taiwan application Serial No. 94117884, filed May 31, 2005, the subject matter of which is incorporated herein by reference.

### BACKGROUND OF THE INVENTION

1. Field of the Invention

The invention relates in general to a zoom lens of projector, and more particularly to a zoom lens of projector having a long back focus length.

2. Description of the Related Art

Digital light processing (DLP) projector adopting digital micro-mirror device (DMD) panel has gradually become a mainstream projector. And yet, how to enhance the quality of the image projected by the DLP projector is still an imminent issue to be resolved. In a projector, the design and quality of the zoom lens which scales the size of the projected image are essential factors determining the quality of the projected images.

Nowadays, the technology of zoom lens applied in an ordinary camera or a digital camera is matured. If the zoom lens of digital camera is directly applied in a DLP projector, a quality image projection can hardly be achieved, and the reasons are disclosed below. Firstly, the zoom lens of digital camera receives external optical signals and then projects the optical signals onto a charge coupled device (CCD), but the zoom lens of projector receives the image generated by the digital micro-mirror device (DMD) and then projects the generated image onto a screen to be viewed by the user. It can be seen that the work environment for the zoom lens of digital camera is different from the work environment of the zoom lens of projector.

Furthermore, compared with a digital camera, the DMD of projector has smaller pixels, therefore the zoom lens of projector requires a higher level of resolution. While the image projected by the projector is for the user to view, the viewer has a higher requirement of color aberration. Consequently, when the zoom lens of digital camera is applied in a projector, a poor display quality would occur quite often. Besides, a projector requires more optical elements than a digital camera does. Since the zoom lens of digital camera has a shorter back focal length, the disposition of the optical elements of projector would be subject to several restrictions if the zoom lens of digital camera is directly applied to a projector.

### SUMMARY OF THE INVENTION

It is therefore an object of the invention to provide a zoom lens, which is designed according to the characteristics of projector and possesses quality projection of images when applied in a projector.

The invention achieves the above-identified object by providing a zoom lens having a long back focal length disposed in a projector. The zoom lens includes a first lens group and a second lens group from the image side in order, The first lens group has a negative effective power Φ_{U1}. The second lens group has a positive effective power Φ_{U2}. The zoom lens has an equivalent power Φ₀ and a back focal length BFL, where BFL*Φ₀≧1.0, |Φ_{U1}|/Φ₀>0.6, and Φ_{U2}/Φ₀>0.6. By adjusting the positions of the first and the second lens groups, the size of the image projected on the screen by the projector is adjusted accordingly.

Other objects features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a diagram of a zoom lens according to a preferred embodiment of the invention when applied in a projector;

FIG. 2 is a diagram of a zoom lens according to a preferred embodiment of the invention; and

FIG. 3 is a diagram of a zoom lens in FIG. 2 when at a wide-angle mode and a long-distance mode.

### DETAILED DESCRIPTION OF THE INVENTION

The zoom lens of the invention is designed according to the characteristics of the projector. After tremendous efforts and trials, the conditions suitable for the zoom lens of projector are disclosed.

The zoom lens of the present embodiment has the characteristics of long back focal length, high resolution, low color aberration, high penetration rate, large aperture, squared image and wide view-angle. Each characteristic is particularly designed for the projector, therefore when the zoom lens of the invention is applied in a projector, an excellent display effect can be achieved

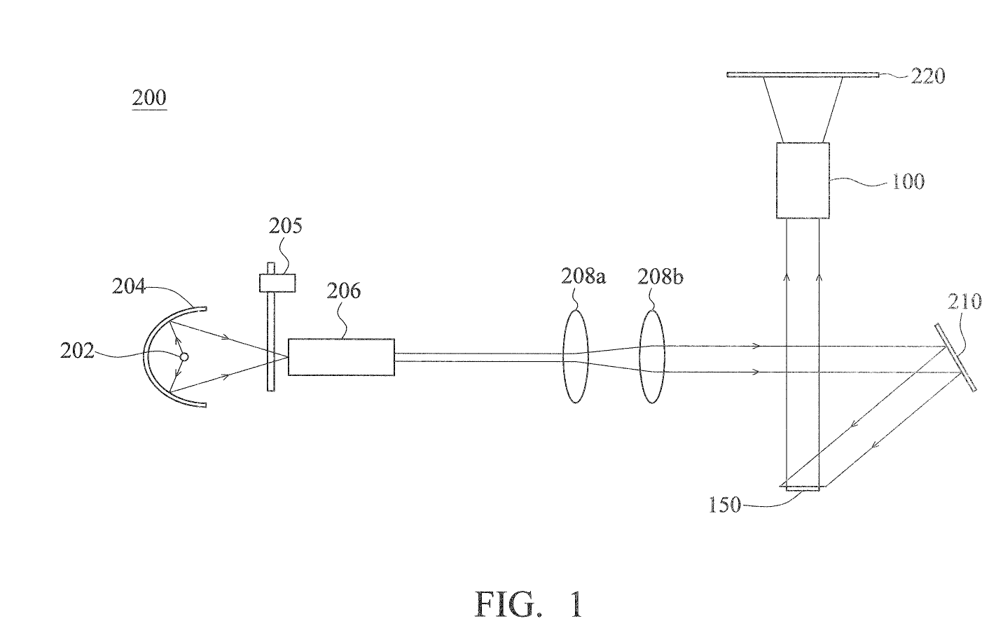

Referring to FIG. 1, a diagram of a zoom lens according to a preferred embodiment of the invention when applied in a projector is shown. Zoom lens 100 of the present embodiment is disposed in a projector 200. The projector 200 may include a light source 202, a reflector 204, a color wheel 205, a light pipe 206, lenses 208a and 208b, a folder mirror, an imaging element 150 and a lens 100.

The light source 202 is used for generating a light. The reflector 204 is used for reflecting the light to the color wheel 205. The color wheel 205 is used for separating the colors of the light passing through. The light pipe 206 is used for receiving the light passing through the color wheel 205 and outputting the light to the lenses 208a and lens 208b. The lenses 208a and lens 208b are used for converging the light. The folder mirror 210 is used for receiving the converged light and then projecting the converged light to the imaging element 150. The imaging element 150 such as a digital micro-mirror device (DMD) for instance is used for receiving the light and generating an image accordingly. The zoom lens 100 of the present embodiment is preferably disposed adjacent to the imaging element 150 for receiving the image generated by the imaging element 150 and then projecting the image onto the screen 220.

The image projected by the lens 100 is formed on the screen 220, so the screen 220 is an image side with respect to the lens 100. The lens 100 receives the image generated by the imaging element 150, so the imaging element 150 is an object side with respect to the lens 100.

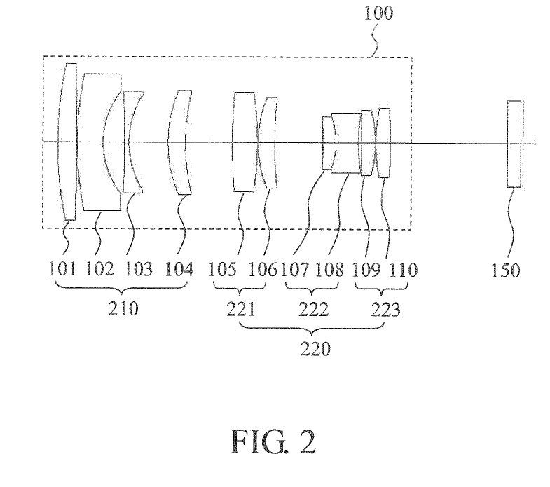

Referring to FIG. 2, a diagram of a zoom lens according to a preferred embodiment of the invention is shown. The zoom lens 100 includes a first lens group 210 and a second lens group 220 disposed from the image side to the imaging element 150 in order. The first lens group 210 has a negative effective power Φ_{U1} and includes a first lens 101, a second lens 102, a third lens 103 and a fourth lens 104 disposed from the image side in order. The first lens 101 has a positive power Φ₁. The second lens 102 has a negative power Φ₂, such as a meniscus for instance. The second lens 102 of the meniscus is concaved to the object side. The third lens 103 has a negative power Φ₃. The fourth lens 104 has a positive power Φ₄.

The second lens group 220 has a positive effective power Φ_{U2} and includes a first lens assembly 221, a second lens assembly 222 and a third lens assembly 223 disposed from the image side to the imaging element 150 in order. The first lens assembly 221 has a positive power Φ_{A1} and includes a fifth lens 105 and a sixth lens 106 for instance. The fifth lens 105 and the sixth lens 106 are disposed between the fourth lens 104 and the second lens assembly 222 and from the image side in order.

The second lens assembly 222 has a negative power Φ_{A2} and includes a seventh lens 107 and the eighth lens 108 for instance. The seventh lens 107 and the eighth lens 108 are disposed between the first lens assembly 221 and the third lens assembly 223 and from the image side in order. The seventh lens 107 and the eighth lens 108 are preferably a doublet lens.

The third lens assembly 223 has a positive power Φ_{A3} and includes a ninth lens 109 and the tenth lens 110 for instance. The ninth lens 109 and the tenth lens 110 are disposed between the second lens assembly 222 and imaging element 150 and from the image side in order.

zoom lens 100 has an equivalent power Φ₀ and back focal length BFL, BFL*Φ₀≧1.0, |Φ_{U1}|/Φ₀>0.6, and Φ_{U2}/Φ₀>0.6. The zoom lens 100 adjusts the size of the image projected on the screen by the projector by adjusting positions of the first lens group 210 and the second lens group 220.

Furthermore, the negative equivalent power Φ_{U1} and positive equivalent power Φ_{U2} of the zoom lens 100 further satisfy the condition of 0.8<|Φ_{U1}/Φ_{U2}|<1.0. The effective focal length EFL of the zoom lens 100 is also preferable to satisfy the condition of 20 mm<EFL<23 mm. The zoom lens 100 can have a lens speed F (f-number) for instance to satisfy the condition of 2.6<F<3.0. The zoom lens can further include an aperture stop disposed between the first lens assembly 221 and the second lens assembly 222.

For example, in the zoom lens 100 of the present embodiment, the radii of the front and the rear surfaces of the first lens 101 are substantially and respectively equal to 87.72 and −594.24 unit length. The diameters of the front and the rear surfaces of the first lens 101 are substantially and respectively equal to 36 and 36 unit length. the distance between the vertex of the front surface of the first lens 101 and the vertex of the rear surface of the first lens 101 is substantially equal to 4.36 unit length. The refractivity of the first lens 101 is substantially equal to 1.59, and the Abbe number of the first lens 101 is substantially equal to 61.2.

The radii of the front and the rear surfaces of the second lens 102 are substantially and respectively equal to 79.77 and 19.19 unit length. The diameters of the front and the rear surfaces of the second lens 102 are substantially and respectively equal to 31.49 and 23.61 unit length. The distance between the vertex of the front surface of the second lens 102 and the vertex of the rear surface of the second lens 102 is substantially equal to 5.98 unit length. The refractivity of the second lens 102 is substantially equal to 1.80, and the Abbe number of the second lens 102 is substantially equal to 35.0. The distance between the vertex of the rear surface of the first lens 101 and the vertex of the front surface of the second lens 102 is substantially equal to 0.15 unit length.

The radii of the front and the rear surfaces of the third lens 103 are substantially and respectively equal to −189.83 and 20.91 unit length The diameters of the front and the rear surfaces of the third lens 103 are substantially and respectively equal to 23.33 and 22.03 unit length. The distance between the vertex of the front surface of the third lens 103 and the vertex of the rear surface of the third lens 103 is substantially equal to 1 unit length. The refractivity of the third lens 103 is substantially equal to 1.49, and the Abbe number of the third lens 103 is substantially equal to 70.2. The distance between the vertex of the rear surface of the second lens 102 and the vertex of the front surface of the third lens 103 is substantially equal to 4.97 unit length.

The radii of the front and the rear surfaces of the fourth lens 104 are substantially and respectively equal to 30.46 and 50.53 unit length. The diameters of the front and the rear surfaces of the fourth lens 104 are substantially and respectively equal to 23.88 and 23.19 unit length. The distance between the vertex of the front surface of the fourth lens 104 and the vertex of the rear surface of the fourth lens 104 is substantially equal to 4.06 unit length. The refractivity of the fourth lens 104 is substantially equal to 1.78, and the Abbe number of the fourth lens 104 is substantially equal to 26.3. The distance between the vertex of the rear surface of the third lens 103 and the vertex of the front surface of the fourth lens 104 is substantially equal to 9.01 unit length.

The radii of the front and the rear surfaces of the fifth lens 105 are substantially and respectively equal to 135.83 and −72.22 unit length. The diameters of the front and the rear surfaces of the fifth lens 105 are substantially and respectively equal to 22.81 and 22.39 unit length. The distance between the vertex of the front surface of the fifth lens 105 and the vertex of the rear surface of the fifth lens 105 is substantially equal to 5.86 unit length. The refractivity of the fifth lens 105 is substantially equal to 1.69, and the Abbe number of the fifth lens 105 is substantially equal to 53.2. The distance between the vertex of the rear surface of the fourth lens 104 and the vertex of the front surface of the fifth lens 105 is adjustable. The distance is substantially equal to 10.84˜5 unit length.

The radii of the front and the rear surfaces of the sixth lens 106 are substantially and respectively equal to 27.44 and 83.81 unit length. The diameters of the front and the rear surfaces of the sixth lens 106 are substantially and respectively equal to 21 and 20 unit length. The distance between the vertex of the front surface of the sixth lens 106 and the vertex of the rear surface of the sixth lens 106 is substantially equal to 3.79 unit length. The refractivity of the sixth lens 106 is substantially equal to 1.72, and the Abbe number of the sixth lens 106 is substantially equal to 50.2. The distance between the vertex of the rear surface of the fifth lens 105 and the vertex of the front surface of the sixth lens 106 is substantially equal to 0.12 unit length.

The distance between the aperture stop and the sixth lens 106 is substantially equal to 11.05 unit length, and the diameter of the aperture stop is substantially equal to 11.74 unit length.

The radii of the front and the rear surfaces of the seventh lens 107 are substantially and respectively equal to −84.23 and −17.96 unit length. The diameters of the front and the rear surfaces of the seventh lens 107 are substantially and respectively equal to 11.74 and 12.11 unit length. The distance between the vertex of the front surface of the seventh lens 107 and the vertex of the rear surface of the seventh lens 107 is substantially equal to 2.93 unit length. The refractivity of the seventh lens 107 is substantially equal to 1.49, and the Abbe number of the seventh lens 107 is substantially equal to 70.2. The distance between the vertex of the aperture stop and the vertex of the front surface of the seventh lens 107 is substantially equal to 0.22 unit length.

The radii of the front and the rear surfaces of the eighth lens 108 are substantially and respectively equal to −17.96 and 35.57 unit length. The diameters of the front and the rear surfaces of the eighth lens 108 are substantially and respectively equal to 12.11 and 13.87 unit length. The distance between the vertex of the front surface of the eighth lens 108 and the vertex of the rear surface of the eighth lens 108 is substantially equal to 5.16 unit length. The refractivity of the eighth lens 108 is substantially equal to 1.76, and the Abbe number of the eighth lens 108 is substantially equal to 27.5. The rear surface of the seventh lens 107 and the front surface of the eighth lens 108 are substantially stacked together.

The radii of the front and the rear surfaces of the ninth lens 109 are substantially and respectively equal to 213.99 and −29.73 unit length. The diameters of the front and the rear surfaces of the ninth lens 109 are substantially and respectively equal to 13.97 and 14.91 unit length. The distance between the vertex of the front surface of the ninth lens 109 and the vertex of the rear surface of the ninth lens 109 is substantially equal to 3.27 unit length. The refractivity of the ninth lens 109 is substantially equal to 1.72, and the Abbe number of the ninth lens 109 is substantially equal to 50.2. The distance between the vertex of the rear surface of the eighth lens 108 and the vertex of the front surface of the ninth lens 109 is substantially equal to 0.68 unit length.

The radii of the front and the rear surfaces of the tenth lens 110 are substantially and respectively equal to 39.97 and −93.04 unit length. The diameters of the front and the rear surfaces of the tenth lens 110 are substantially and respectively equal to 16 and 16 unit length. The distance between the vertex of the front surface of the tenth lens 110 and the vertex of the rear surface of the tenth lens 110 is substantially equal to 3.41 unit length. The refractivity of the tenth lens 110 is substantially equal to 1.72, and the Abbe number of the tenth lens 110 is substantially equal to 50.2. The distance between the vertex of the rear surface of the ninth lens 109 and the vertex of the front surface of the tenth lens 110 is substantially equal to 0.1 unit length.

The distance between the vertex of the front surface of the imaging element 150 and the vertex of the rear surface of the imaging element 150 is substantially equal to 3 unit length for instance. The refractivity of the imaging element 150 is 1.49 for instance, and the Abbe number of the imaging element 150 is 70.2 for instance. The distance between the imaging element 150 and the tenth lens 110 is and is substantially equal to 27˜30.11 unit length.

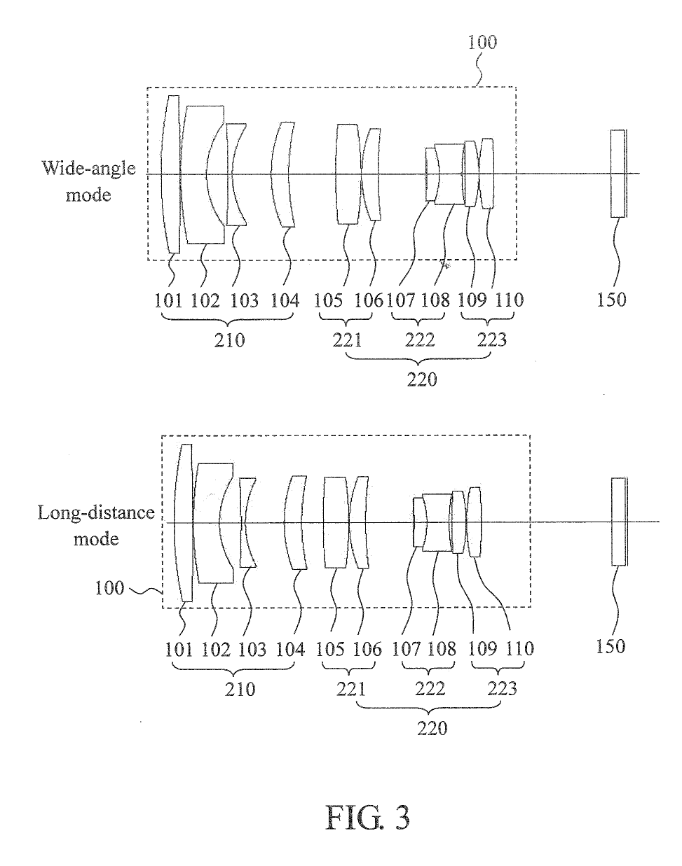

Referring to FIG. 3, a diagram of a zoom lens in FIG. 2 when at a wide-angle mode and a long-distance mode is shown. The zoom lens 100 of the present embodiment has a wide-angle mode and a long-distance mode. By adjusting the distance between the first lens group 210 and the second lens group 220 and adjusting the distance between the second lens group 220 and the imaging element 150, the size of the image projected by the zoom lens 100 is adjusted accordingly.

In the wide-angle mode, the focal length of the zoom lens 100 is substantially equal to 20 mm. The distance between the first lens group 210 and the second lens group 220, that is, the distance between the fourth lens 104 and the fifth lens 105, is substantially equal to 10.84 unit length. The distance between the second lens group 220 and the imaging element 150, that is, the distance between the tenth lens 110 and the imaging element 150, is substantially equal to 27 unit length. When the zoom lens 100 projects an image onto a screen 2 m afar, the diagonal of the image projected by the zoom lens 100 substantially measures 55 inches. That is, in the wide-angle mode, the image projected by the zoom lens 100 is larger.

In the long-distance mode, the focal length of the zoom lens 100 is substantially equal to 23 mm, and the distance between the first lens group 210 and the second lens group 220, that is, the distance between the fourth lens 104 and the fifth lens 105, is substantially equal to 5 unit length. The distance between the second lens group 220 and the imaging element 150, that is, the distance between the tenth lens 110 and the imaging element 150, is substantially equal to 30.11 unit length. When the zoom lens 100 projects an image onto a screen 2 m afar the diagonal of the image projected by the zoom lens 100 substantially measures 48 inches. That is, in the long-distance mode, the image projected by the zoom lens 100 is smaller.

The zoom lens 100 can be switched between the wide-angle mode and the long-distance mode to adjust the distance between the first lens group 210 and the second lens group 220 and the distance between the second lens group 220 and the imaging element 150, so that the size of the projected image is adjusted accordingly.

The zoom lens of the present embodiment has the characteristics of long back focal length, high resolution, low color aberration, high penetration rate, large aperture, squared image and wide view-angle. The projector has a zoom lens having a long back focal length, so that the projector can be equipped with more optical elements, and the projector has a larger flexibility in terms of the design of optical path. However, a zoom lens with high resolution is very suitable to go with a DMD whose pixels are small, so that a quality projection of image can be achieved. Since the zoom lens of the present embodiment is designed according to the spectrum characteristics of the light emitted by the bulb of the projector, the zoom lens having a smaller color aberration and a better color display improves the quality of image display of the zoom lens. Moreover, the zoom lens of the present embodiment has an appropriate number of lenses and provides an excellent penetration rate. With the characteristics of large aperture, squared image and wide view-angle, the conditions of image display of projector are satisfied, allowing the user to view the image from various angles. Therefore, the zoom lens of the present embodiment can be applied to a projector and prove an excellent visual effect to the viewer. Furthermore, the zoom lens of present embodiment does not employ any non-spherical lens, so that zoom lens has a smaller tolerance and that the manufacturing is made easier.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A zoom lens having a long back focus, wherein the zoom lens is disposed in a projector and from an image side in order comprises:
a first lens group having a negative effective power Φ_{U1}; and
a second lens group having a positive effective power Φ_{U2};
wherein the zoom lens has an equivalent power Φ₀ and a back focal length BFL, where BFL*Φ₀≧1.0, |Φ_{U1}|/Φ₀>0.6, and Φ_{U2}/Φ₀>0.6, and the size of the image projected on a screen by the projector is adjusted by adjusting the positions of the first lens group and the second lens group.

2. The zoom lens according to claim 1, wherein the first lens group comprises:
a first lens having a positive power Φ₁;
a second lens having a negative power Φ₂;
a third lens having a negative power Φ₃; and
a fourth lens having a positive power Φ₄;
wherein the first lens, the second lens, the third lens and the fourth lens are disposed from the image side in order.

3. The zoom lens according to claim 2, wherein the second lens group comprises:
a first lens assembly having a positive power Φ_{A1};
a second lens assembly having a negative power Φ_{A2}; and
a third lens assembly having a positive power Φ_{A3};
wherein the first lens assembly, the second lens assembly and the third lens assembly are disposed from the image side in order.

4. The zoom lens according to claim 3, wherein the negative equivalent power Φ_{U1} and the positive equivalent power Φ_{U2} further satisfy the following condition:
0.8<|Φ_{U1}/Φ_{U2}<1.0.

5. The zoom lens according to claim 3, having an effective focal length EFL which satisfies the following condition:
20 mm<EFL<23 mm.

6. The zoom lens according to claim 3, having a lens speed F (f-number) which satisfies the following condition:
2.6<F<3.0.

7. The zoom lens according to claim 3, wherein the second lens is meniscus and is concaved to an object side.

8. The zoom lens according to claim 3, wherein the first lens assembly comprises two lenses.

9. The zoom lens according to claim 3, wherein the second lens assembly is a doublet lens.

10. The zoom lens according to claim 3, wherein the third lens assembly comprises two lenses.

11. The zoom lens according to claim 3, further comprising an aperture stop disposed between the first lens assembly and the second lens assembly.

12. The zoom lens according to claim 11, wherein the curvature radii of a front surface and a rear surface of the first lens are substantially and respectively equal to 87.72 and −594.24 unit length, the diameters of the front surface and the rear surface of the first lens are substantially and respectively equal to 36 and 36 unit length, the distance between the vertex of the front surface of the first lens and the vertex of the rear surface of the first lens is substantially equal to 4.36 unit length, the refractivity of the first lens is substantially equal to 1.59, and the Abbe number of the first lens is substantially equal to 61.2;
the curvature radii of a front surface and a rear surface of the second lens are substantially and respectively equal to 79.77 and 19.19 unit length, the diameters of the front surface and the rear surface of the second lens are substantially and respectively equal to 31.49 and 23.61 unit length, the distance between the vertex of the front surface of the second lens and the vertex of the rear surface of the second lens is substantially equal to 5.98 unit length, the refractivity of the second lens is substantially equal to 1.80, the Abbe number of the second lens is substantially equal to 35.0, the distance between the vertex of the rear surface of the first lens and the vertex of the front surface of the second lens is substantially equal to 0.15 unit length;
the curvature radii of a front surface and a rear surface of the third lens are substantially and respectively equal to −189.83 and 20.91 unit length, the diameters of the front surface and the rear surface of the third lens are substantially and respectively equal to 23.33 and 22.03 unit length, the distance between the vertex of the front surface of the third lens and the vertex of the rear surface of the third lens is substantially equal to 1 unit length, the refractivity of the third lens is substantially equal to 1.49, the Abbe number of the third lens is substantially equal to 70.2, the distance between the vertex of the rear surface of the second lens and the vertex of the front surface of the third lens is substantially equal to 4.97 unit length;
the curvature radii of a front surface and a rear surface of the fourth lens are substantially and respectively equal to 30.46 and 50.53 unit length, the diameters of the front surface and the rear surface of the fourth lens are substantially and respectively equal to 23.88 and 23.19 unit length, the distance between the vertex of the front surface of the fourth lens and the vertex of the rear surface of the fourth lens is substantially equal to 4.06 unit length, the refractivity of the fourth lens is substantially equal to 1.78, the Abbe number of the fourth lens is substantially equal to 26.3, the distance between the vertex of the rear surface of the third lens and the vertex of the front surface of the fourth lens is substantially equal to 9.01 unit length;
the first lens assembly comprises a fifth lens and a sixth lens, wherein the fifth lens and the sixth lens are disposed from the image side in order, the curvature radii of a front surface and a rear surface of the fifth lens are substantially and respectively equal to 135.83 and −72.22 unit length, the diameters of the front surface and the rear surface of the fifth lens are substantially and respectively equal to 22.81 and 22.39 unit length, the distance between the vertex of the front surface of the fifth lens and the vertex of the rear surface of the fifth lens is substantially equal to 5.86 unit length, the refractivity of the fifth lens is substantially equal to 1.69, the Abbe number of the fifth lens is substantially equal to 53.2, the distance between the vertex of the rear surface of the fourth lens and the vertex of the front surface of the fifth lens is adjustable and is substantially equal to 10.84˜5 unit length;
the curvature radii of a front surface and a rear surface of the sixth lens are substantially and respectively equal to 27.44 and 83.81 unit length, the diameters of the front surface and the rear surface of the sixth lens substantially and respectively equal to 21 and 20 unit length, the distance between the vertex of the front surface of the sixth lens and the vertex of the rear surface of the sixth lens is substantially equal to 3.79 unit length, the refractivity of the sixth lens is substantially equal to 1.72, the Abbe number of the sixth lens is substantially equal to 50.2, the distance between the vertex of the rear surface of the fifth lens and the vertex of the front surface of the sixth lens is substantially equal to 0.12 unit length;
the distance between the aperture stop and the sixth lens is 11.05 unit length, and the diameter of the aperture stop is substantially equal to 11.74 unit length;
the second lens assembly comprises a seventh lens and an eighth lens, wherein the seventh lens and the eighth lens are disposed from the image side in order, the curvature radii of a front surface and a rear surface of the seventh lens are substantially and respectively equal to −84.23 and −17.96 unit length, the diameters of the front surface and the rear surface of the seventh lens are substantially and respectively equal to 11.74 and 12.11 unit length, the distance between the vertex of the front surface of the seventh lens and the vertex of the rear surface of the seventh lens is substantially equal to 2.93 unit length, the refractivity of the seventh lens is substantially equal to 1.49, the Abbe number of the seventh lens is substantially equal to 70.2, and the distance between the vertex of the aperture stop and the vertex of the front surface of the seventh lens is substantially equal to 0.22 unit length;
the curvature radii of a front surface and a rear surface of the eighth lens are substantially and respectively equal to −17.96 and 35.57 unit length, the diameters of the front surface and the rear surface of the eighth lens are substantially and respectively equal to 12.11 and 13.87 unit length, the distance between the vertex of the front surface of the eighth lens and the vertex of the rear surface of the eighth lens is substantially equal to 5.16 unit length, the refractivity of the eighth lens is substantially equal to 1.76, the Abbe number of eighth lens is substantially equal to 27.5, the rear surface of the seventh lens and the front surface of the eighth lens are substantially stacked together;
the third lens assembly comprises a ninth lens and a tenth lens, wherein the ninth lens and the tenth lens are disposed from the image side in order, the curvature radii of a front surface and a rear surface of the ninth lens are substantially and respectively equal to 213.99 and −29.73 unit length, the diameters of the front surface and the rear surface of the ninth lens are substantially and respectively equal to 13.97 and 14.91 unit length, the distance between the vertex of the front surface of the ninth lens and the vertex of the rear surface of the ninth lens is substantially equal to 3.27 unit length, the refractivity of the ninth lens is substantially equal to 1.72, the Abbe number of the ninth lens is substantially equal to 50.2, and the distance between the vertex of the rear surface of the eighth lens and the vertex of the front surface of the ninth lens is substantially equal to 0.68 unit length;
the curvature radii of a front surface and a rear surface of the tenth lens are substantially and respectively equal to 39.97 and −93.04 unit length, the diameters of the front surface and the rear surface of the tenth lens are substantially and respectively equal to 16 and 16 unit length, the distance between the vertex of the front surface of the tenth lens and the vertex of the rear surface of the tenth lens is substantially equal to 3.41 unit length, the refractivity of the tenth lens is substantially equal to 1.72, the Abbe number of the tenth lens is substantially equal to 50.2, and the distance between the vertex of the rear surface of the ninth lens and the vertex of the front surface of the tenth lens is substantially equal to 0.1 unit length; and
an imaging element whose distance from the tenth lens is adjustable, wherein the distance between the imaging element and the tenth lens is substantially equal to 27˜30.11 unit length.

13. The zoom lens according to claim 11, wherein the imaging element is a digital micro-mirror device (DMD).

14. The zoom lens according to claim 11, wherein the distance between the vertex of a front surface of the imaging element and the vertex of a rear surface of the imaging element is substantially equal to 3 unit length, the refractivity of the imaging element is substantially equal to 1.49, and the Abbe number of the imaging element is substantially equal to 70.2.

15. The zoom lens according to claim 1, wherein the negative equivalent power Φ_{U1} and the positive equivalent power Φ_{U2} further satisfy the following condition:
0.8<|Φ_{U1}/Φ_{U2}|<1.0.

16. The zoom lens according to claim 1, having an effective focal length EFL which satisfies the following condition:
20 mm<EFL<23 mm.

17. The zoom lens according to claim 1, having a lens speed F (f-number) which satisfies the following condition:
2.6<F<3.0.

18. The zoom lens according to claim 1, further comprising an aperture stop disposed between the first lens assembly and the second lens assembly.
